(19) United States
(12) Patent Application Publication
(10) Pub. No.: US 2023/0076208 A1
(43) Pub. Date: Mar. 9, 2023

(54) SERVICE PROCESSING METHOD AND APPARATUS IN OTN AND ELECTRONIC DEVICE

(71) Applicant: ZTE CORPORATION, Shenzhen, Guangdong (CN)

(72) Inventors: Yuanbin ZHANG, Shenzhen, Guangdong (CN); Yan YUAN, Shenzhen, Guangdong (CN)

(21) Appl. No.: 17/801,480

(22) PCT Filed: Oct. 15, 2020
(86) PCT No.: PCT/CN2020/121260

§ 371 Date: Aug. 22, 2022

(30) Foreign Application Priority Data
Feb. 28, 2020 (CN) 202010126946.8

(51) Int. Cl. H04Q 11/00; H04J 3/16

(52) U.S. Cl. CPC H04Q 11/0062; H04J 3/1652; H04Q 2011/0086

(57) ABSTRACT

A service processing method in an optical transport network (OTN), including: mapping a client service to a service container; mapping the service container to an OTN frame or an OTN multi-frame composed of a plurality of continuous OTN frames, where a payload area of the OTN frame or the OTN multi-frame includes M unit blocks configured to bear the service container; bearing length indication information of the unit blocks in an overhead area of the OTN frame or the OTN multi-frame; and sending the OTN frame or the OTN multi-frame. Embodiments of the present disclosure further provide a service processing apparatus in an OTN, an electronic device, and a computer-readable medium.

### TECHNICAL FIELD

Embodiments of the present disclosure relate to the field of optical communication technologies, and in particular, to a service processing method and apparatus in an optical transport network (OTN), an electronic device, and a computer-readable medium.

### BACKGROUND

In the definition of the existing optical transport network (OTN), a method for loading a plurality of service signals into a payload of an OTN signal includes: firstly, dividing an area of an OTN signal into n time slots implemented in a byte interleaving mode; then loading a service signal to one or more time slots of the payload of the OTN signal.

According to the existing OTN standard G.709, the minimum time slot granularity in the existing OTN technology is 1.25 Gbps. When bearing services with a bandwidth lower than 1.25 Gbps, such as small bandwidth services like fast Ethernet (FE) services, synchronous transfer module-1 (STM-1) services, E1 services, or the like, the bandwidth waste of the OTN is serious. For example, when a signal E1 with a bandwidth of 2.048 Mbps is loaded into a time slot with a bandwidth of 1.25 Gbps, up to more than 99% of the bandwidth is wasted. Therefore, a transmission technology to implement a method for bearing fine-grained services in an OTN with high efficiency is desired.

In addition, the processing of the client service is different depending on different scenarios, where some may desire cross processing but some may not, so that a mechanism that can meet low-latency requirements in different scenarios is desired.

### SUMMARY

Embodiments of the present disclosure provide a service processing method and apparatus in an optical transport network (OTN), an electronic device, and a computer-readable medium.

In a first aspect, an embodiment of the present disclosure provides a service processing method in an optical transport network (OTN), including: mapping a client service to a service container; mapping the service container to an OTN frame or an OTN multi-frame composed of a plurality of continuous OTN frames, where a payload area of the OTN frame or the OTN multi-frame includes M unit blocks configured to bear the service container; bearing length indication information of the unit blocks in an overhead area of the OTN frame or the OTN multi-frame; and sending the OTN frame or the OTN multi-frame.

In some embodiments, the unit block has a length N times a basic unit, and when the payload area of a single OTN frame is divided into M unit blocks having an equal length, a length U of the basic unit equals to a length of one unit block, where N is a positive integer.

In some embodiments, before bearing the length indication information of the unit blocks in the overhead area of the OTN frame or the OTN multi-frame, the method further includes: determining a value of the multiple N.

In some embodiments, when N>1, the service container is mapped to an OTN multi-frame composed of N continuous OTN frames, the payload area of the OTN multi-frame is divided into M unit blocks each having a length of N*U, and some of bits in the overhead area of the OTN frame are used for multi-frame counting statistics of the N OTN frames.

In some embodiments, the length indication information includes the multiple N; or the length indication information includes the multiple N and the length U.

In some embodiments, the service container includes: an optical channel data unit (ODU) frame or an optical service unit (OSU) frame.

In some embodiments, the processing method further includes: receiving the OTN frame or the OTN multi-frame; acquiring the length indication information from the overhead area of the OTN frame or the OTN multi-frame to determine the length of the unit block; determining distribution positions of the unit blocks from the length of the unit block, and de-mapping a service container from the unit blocks; and acquiring the client service from the service container.

In a second aspect, an embodiment of the present disclosure further provides a service processing apparatus in an optical transport network (OTN), including: a first mapping module configured to map a client service to a service container; a second mapping module configured to map the service container to an OTN frame or an OTN multi-frame composed of a plurality of continuous OTN frames, where a payload area of the OTN frame or the OTN multi-frame includes M unit blocks configured to bear the service container; a bearing module configured to bear length indication information of the unit blocks in an overhead area of the OTN frame or the OTN multi-frame; and a sending module configured to send the OTN frame or the OTN multi-frame.

In some embodiments, the processing apparatus further includes: a receiving module configured to receive the OTN frame or the OTN multi-frame; a determining module configured to acquire the length indication information from the overhead area of the OTN frame or the OTN multi-frame to determine a length of the unit block; a de-mapping module configured to determine distribution positions of the unit blocks from the length of the unit block, and de-map a service container from the unit blocks; and an acquiring module configured to acquire the client service from the service container.

In a third aspect, an embodiment of the present disclosure further provides an electronic device, including: at least one processor; and a memory having at least one program stored thereon which, when executed by the at least one processor, cause the at least one processor to implement the service processing method according to the first aspect.

In a fourth aspect, an embodiment of the present disclosure further provides a computer-readable medium having a computer program stored thereon which, when executed by a processor, causes the service processing method according to the first aspect to be implemented.

With the technical solution provided in the embodiments of the present disclosure, the problem of serious bandwidth waste caused by transmitting optical transmission services by dividing the payload area into time slots in the existing art can be solved, and the effect of improving the OTN bandwidth utilization rate can be achieved. In addition, the technical solution provided in the embodiments of the present disclosure can meet low-latency requirements under different application scenarios.

### BRIEF DESCRIPTION OF DRAWINGS

FIG. 1 is a schematic diagram of an optical channel frame structure according to an embodiment of the present disclosure;

FIG. 2 is a schematic diagram showing a payload area of an optical channel frame structure divided into 4 time slots in an optical transport standard in the related art;

FIG. 3 is a flowchart of a service processing method in an OTN according to an embodiment of the present disclosure;

FIG. 4a is a schematic diagram showing a payload area of one ODU0 frame divided into 952 unit blocks;

FIG. 4b is a schematic diagram showing payload areas of two continuous ODU0 frames divided into 952 unit blocks;

FIG. 4c is a schematic diagram showing payload areas of four continuous ODU0 frames divided into 952 unit blocks;

FIG. 5 is a schematic diagram showing an ODU0 frame divided into unit blocks and bearing a multiple N and a length U in an embodiment of the present disclosure;

FIG. 6 is a flowchart of another service processing method in an OTN according to an embodiment of the present disclosure;

FIG. 7 is a schematic diagram of a service transmission scenario of example 1;

FIG. 8 is a schematic diagram of a service transmission scenario of example 2;

FIG. 9 is a schematic diagram showing payload areas of 16 continuous ODU0 frames divided into 952 unit blocks;

FIG. 10 is a block diagram of a service processing apparatus in an OTN according to an embodiment of the present disclosure; and

FIG. 11 is a block diagram of an electronic device according to an embodiment of the present disclosure.

### DETAIL DESCRIPTION OF EMBODIMENTS

To improve understanding of the technical solution of the present disclosure for those skilled in the art, the service processing method and apparatus in the OTN, the electronic device, and the computer-readable medium of the present disclosure will be described below in detail in conjunction with the accompanying drawings.

Example embodiments will be described more sufficiently below with reference to the accompanying drawings, but which may be embodied in different forms and should not be construed as limited to the embodiments set forth herein. Rather, these embodiments are provided so that this disclosure will be thorough and complete, and will fully convey the scope of the present disclosure to those skilled in the art.

Embodiments of the present disclosure and features of the embodiments may be combined with each other in the case where there is no conflict.

As used herein, the term “and/or” includes any and all combinations of one or more of the associated listed items.

The terminology used herein is for the purpose of describing specific embodiments only and is not intended to limit the present disclosure. As used herein, the singular forms “a”, “an” and “the” are intended to include the plural forms as well, unless the context clearly indicates otherwise. It will be further understood that as used herein, the terms “comprise” and/or “consist of . . . ” specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the existing art and the present disclosure, and will not be interpreted in an idealized or overly formal sense unless expressly so defined herein.

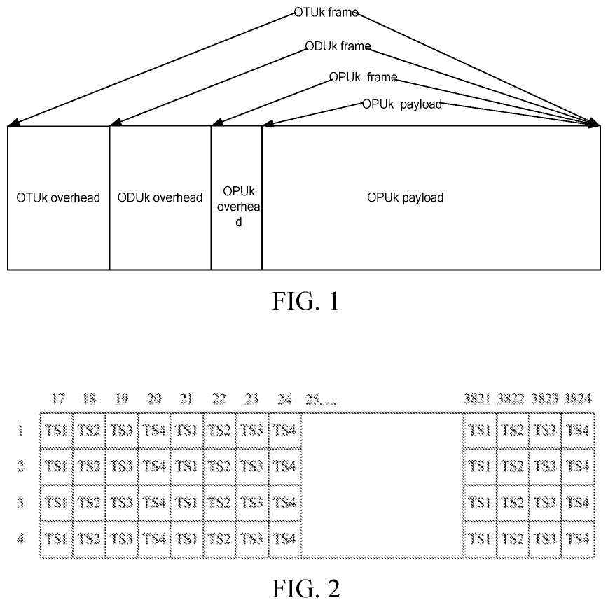

FIG. 1 is a schematic diagram of an optical channel frame structure according to an embodiment of the present disclosure. As shown in FIG. 1, the case where an OTN signal is taken as an optical channel transport unit (OTU) signal is taken in the embodiment of the present disclosure as an example for description. The OTU signal is composed of OTUk frames, and includes an overhead area and a payload area. The overhead area includes: an OTU overhead (denoted as “OTUk overhead”, where k may be 1, 2, 3 or 4), an optical channel data unit (ODU) overhead (denoted as “ODUk overhead”, where k may be 0, 1, 2, 2e, 3 or 4), and an optical channel payload unit (OPU) overhead (denoted as “OPUk overhead”, where k may be 0, 1, 2, 2e, 3 or 4). The remaining part of the OTUk frames after the OTUk overhead is removed is called ODUk frame, the remaining part of the ODUk frames after the ODUk overhead is removed is called OPUk frame, and the remaining part of the OPUk frames after the OPUk overhead is removed is called OPUk payload (i.e., a payload area of an optical channel frame structure). The payload area may be configured to bear service signals.

FIG. 2 is a schematic diagram showing a payload area of an optical channel frame structure divided into 4 time slots in an optical transport standard in the related art. As shown in FIG. 2, in the definition of the existing OTN, a method for loading a plurality of service signals into a payload of an OTN signal includes: dividing the payload of the OTN signal into n time slots, and then loading a service signal to one or more time slots of the payload of the OTN signal. The time slots are implemented in a byte-interleaved manner, and exemplary description is give below by taking the case where a payload area of an OTUk is divided into 4 time series as an example. An OTUk frame is composed of 4 rows and 3,824 columns of byte blocks, where an area corresponding to column numbers 1 to 16 is the overhead area (not shown), and an area corresponding to column numbers 17 to 3,824 is the payload area. Each small block in FIG. 2 represents one byte, and the OPUk payload area of each OPUk frame consists of 4*3,808 bytes arranged in 4 rows and 3,808 columns, as shown in FIG. 2. FIG. 2 shows the case where the OPUk payload is divided into 4 time slots in a byte-interleaved manner. That is, among a total of 3,808 columns, starting from column 17, every adjacent 4 bytes form a group, and the 4 bytes in each group are divided into 4 different time slots TS1, TS2, TS3, and TS4. In other words, starting from column 17, 4 continuous bytes represent 4 time slots, respectively. In this manner, all the 4*3,808 bytes in the OPUk payload are divided into 4 time slots, which are named as TS1, TS2, TS3, and TS4, respectively, and m time slots may accommodate one ODU service (m is smaller than the maximum time slot number n in the OPUk payload, where n=4 in FIG. 2).

According to the existing OTN standard G.709, the smallest ODUk in the OTN is ODU0, and the rate is 1.25G. Theoretically, the OPUk payloads in OTUk frames at all rates should be divided into time slots with a granularity of 1.25G, so that the ODU0 can be loaded most efficiently. At this time, for some services with a smaller bandwidth, such as FE services, STM-1 services, E1 services, or the like, directly bearing the services in time slots would result in serious bandwidth waste.

In addition, the processing of the client service is different depending on different scenarios, where some may desire cross processing but some may not. Therefore, how to ensure the low-latency requirements in different application scenarios is also a technical problem to be solved in the art.

To solve at least one of the above technical problems, the present disclosure provides a corresponding solution, which will be exemplarily described below with reference to the accompanying drawings.

The “basic unit” in the following embodiments specifically refers to a unit in the payload area that occupies a certain number of continuous bits (which may also be referred to as a length of the basic unit), where a specific value of the “certain number” may be preset according to actual needs.

The “unit block” specifically refers to a structure formed by several (one or more) continuous basic units, which is a minimum unit for bearing a service container. Each unit block bears data of at most one service container; and the number of basic units contained in each unit block may be set according to different scenarios, so as to meet the low-latency requirements under different application scenarios. Taking the basic units as units, the unit block may be flexibly arranged according to different multiples of the basic units. In addition, the OTN frame adopts a multi-frame mode, so that unit blocks of different lengths may correspond to the same bandwidth. The specific contents will be described in detail later.

The OTN frame includes a payload area and an overhead area. The overhead area is configured to bear control information, and the payload area is configured to bear service data. In a data frame, the overhead areas of all OTN frames form an overhead area of the data frame, and the payload areas of all OTN frames form a payload area of the data frame.

FIG. 3 is a flowchart of a service processing method in an OTN according to an embodiment of the present disclosure. As shown in FIG. 3, the service processing method in the OTN is applied to a sending side, and includes the following operations S101 to S104.

At operation S101, mapping a client service to a service container.

In an embodiment of the present disclosure, the client service specifically refers to a fine-grained service for an OTN frame. Specifically, a ratio of a bandwidth of the client service to a bandwidth of a payload area of the OTN frame is smaller than a preset ratio, where a specific value of the preset ratio is set by an industry professional. Generally speaking, the preset ratio is less than or equal to 10%. In the embodiment of the present disclosure, it is sufficient to ensure that the bandwidth of the client service is less than the bandwidth of the payload area of the OTN frame.

In an embodiment of the present disclosure, the service container includes: an ODU frame or an optical service unit (OSU) frame. The process of mapping the client service to the service container belongs to conventional technology in the art, and will not be described in detail here.

At operation S102, mapping the service container to an OTN frame or an OTN multi-frame composed of a plurality of continuous OTN frames, a payload area of the OTN frame or the OTN multi-frame including M unit blocks configured to bear the service container.

At operation S103, bearing length indication information of the unit blocks in an overhead area of the OTN frame or the OTN multi-frame.

At operation S104, sending the OTN frame or the OTN multi-frame.

In some embodiments, a length of the unit block is N times a basic unit, and when the payload area of a single OTN frame is divided into M unit blocks having an equal length, a length U of the basic unit equals to a length of one unit block, where N is a positive integer.

In the present disclosure, when N=1, the length of the unit block equals to one basic unit and the service container is mapped to one OTN frame, that is, the unit block is divided by one OTN frame. When N>1, the multiple N has different meanings, including that: one unit block includes N continuous basic units; or the service container is mapped to an OTN multi-frame composed of N continuous OTN frames, that is, the unit block is divided by the OTN multi-frame composed of N OTN frames. Different values of N may be set according to different application scenarios.

In some embodiments, before operation S102, the method further includes: determining a value of the multiple N. The value of the multiple N may be set manually, or may be determined by the device itself according to a certain determination rule based on the application scenario where the device is located. The specific algorithm of the “determination rule” is not limited in the technical solution of the present disclosure, and will be described in detail with reference to specific examples later.

In some embodiments, the OTN frame includes: an ODU frame or a flexible OTN frame (also referred to as FlexO frame). That is, the OTN multi-frame may be a multi-frame composed of a plurality of ODU frames, or a multi-frame composed of a plurality of FlexO frames.

Assuming that the basic unit corresponds to a preset length of U bits, the payload area of one OTN frame has a size of W bits, and one OTN frame is to be divided into M unit blocks, then U=INT(W/M), where INTO is a rounding function.

The case where a basic unit corresponds to a preset length of 16 bytes (128 bits) is taken as an example for the exemplary description below.

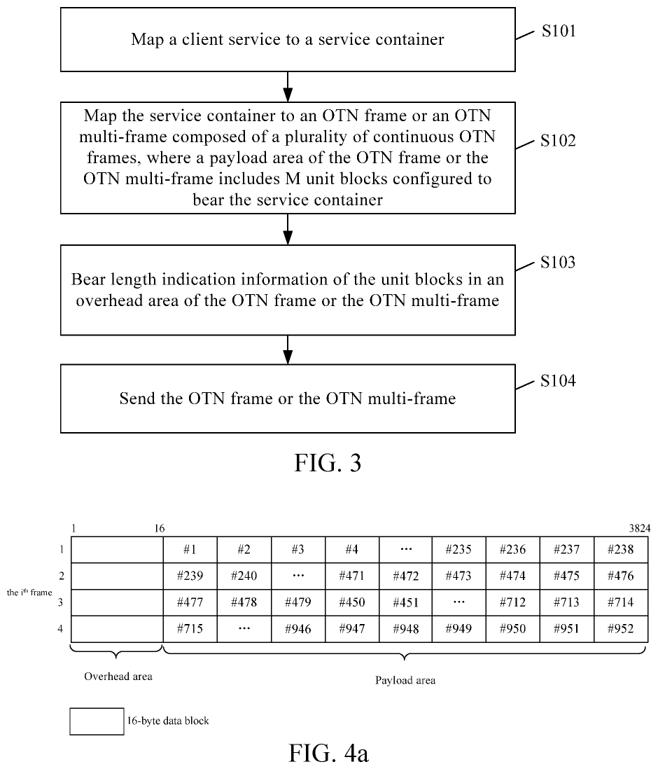

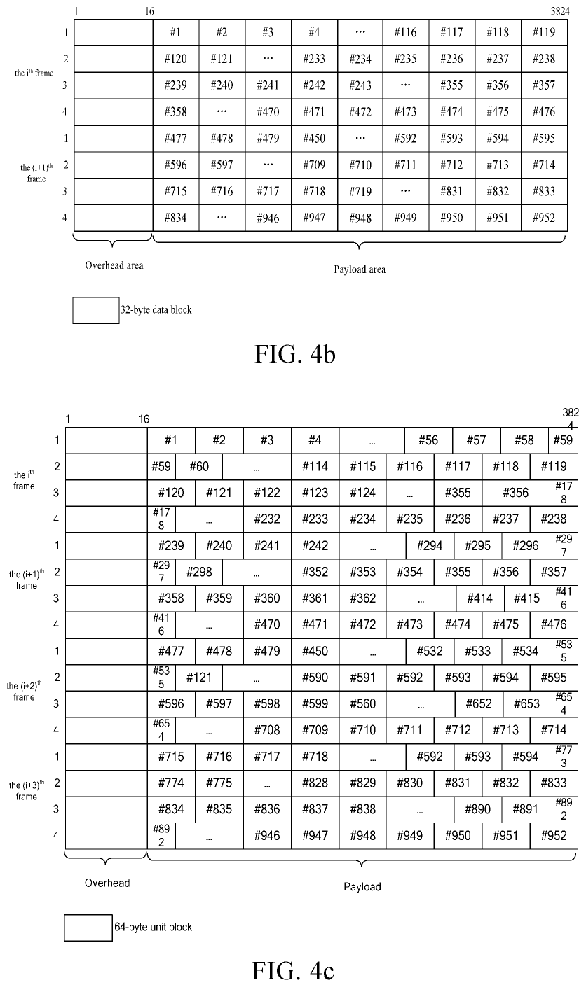

FIG. 4a is a schematic diagram showing a payload area of one ODU0 frame divided into 952 unit blocks. As shown in FIG. 4a, taking an ODU0 frame as an example, the payload area of one ODU0 frame has a length of 4*3,808 bytes. If the payload area of the one ODU0 frame is to be divided into 952 unit blocks, then each unit block in the one ODU0 frame has a size of (4*3,824)/952=16 bytes. At this time, one unit block includes one basic unit (a first length parameter takes a value of 1), the unit block supported by the one ODU0 frame has a bandwidth B=BODU0*16/(4*3,824)≈1.3 Mbps, where BODU0 represents the bandwidth of the ODU0 frame.

FIG. 4b is a schematic diagram showing payload areas of two continuous ODU0 frames divided into 952 unit blocks. As shown in FIG. 4b, in some scenarios, if the length of the unit block is to be adjusted to 32 bytes, then N=2, that is, one unit block includes 2 basic units. In order to still divide into 952 unit blocks each with a length of 32 bytes, the two continuous ODU0 frames are divided as a multi-frame, and each unit block with the length of 32 bytes is still 1.3 Mbps.

FIG. 4c is a schematic diagram showing payload areas of four continuous ODU0 frames divided into 952 unit blocks. As shown in FIG. 4c, in some scenarios, if the length of the unit block is to be adjusted to 64 bytes, then N=4, that is, one unit block includes 4 basic units. In order to still divide into 952 unit blocks each with a length of 64 bytes, the four continuous ODU0 frames are divided as a multi-frame, and each unit block with the length of 64 bytes is still 1.3 Mbps.

The cases where N takes other values are not elaborated herein one by one.

In the present disclosure, the length indication information is configured to indicate a length of the unit block. As an implementation, the length indication information directly indicates a length of the unit block. As another implementation, the length indication information includes some relevant parameters from which the length of the unit block can be derived.

In some embodiments, the length indication information includes a multiple N and a length U of the basic unit, and by multiplying the multiple N by the length U, a length N*U of the unit block is obtained. Apparently, when the length U of the basic unit is agreed between the sender and the receiver in advance, there is no need to transmit the length U anymore, and the length indication information may include merely the multiple N.

In practical applications, when N is greater than 1, the length indication information may be born in an overhead area of a first OTN frame in the OTN multi-frame, or born in an overhead area of a last OTN frame in the OTN multi-frame, or born in an overhead area of each OTN frame in the OTN multi-frame.

As a specific real-time manner, in the overhead area of each OTN frame, an area representing a value of the multiple N occupies 1 byte, and an area representing a value of the length U of the unit block occupies 1 byte.

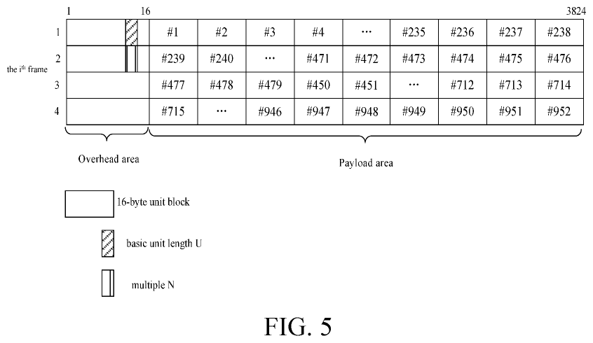

FIG. 5 is a schematic diagram showing an ODU0 frame divided into unit blocks and bearing a multiple N and a length U in an embodiment of the present disclosure. As shown in FIG. 5, as a specific example, a payload area of an ODU0 frame is divided into 952 unit blocks, the 15th byte in a first row of the overhead area of the ODU0 frame is configured to bear the length U, and the 15th byte in a second row of the overhead area of the ODU0 frame is configured to bear the multiple N.

In an embodiment of the present disclosure, the payload area of the OTN frame or the OTN multi-frame is divided into a plurality of unit blocks, which are the minimum units for bearing client services, and since each unit block may have a very small bandwidth, the bandwidth utilization rate can be improved. With the technical solution of the present disclosure, the problem of serious bandwidth waste caused by transmitting optical transmission services by dividing the payload area into time slots in the existing art can be solved, and the effect of improving the OTN bandwidth utilization rate can be achieved.

In some embodiments, when N>1, the service container is mapped to an OTN multi-frame composed of N continuous OTN frames, the payload area of the OTN multi-frame is divided into M unit blocks each having a length of N*U, and some of bits in the overhead area of the OTN frame are used for multi-frame counting statistics of the N OTN frames. That is, a value of the multiple N may be embodied and transmitted through multi-frame counting statistics.

As an example, a multi-frame alignment signal (MFAS) overhead in the OTN frame is reused for the multi-frame counting statistics. Taking a multi-frame composed of 4 continuous ODU0 frames as an example, an MFAS overhead of the first ODU0 frame bears a numerical value of 1 (an 8-bit binary number), an MFAS overhead of the second ODU0 frame bears a numerical value of 2 (an 8-bit binary number), an MFAS overhead of the third ODU0 frame bears a numerical value of 3 (an 8-bit binary number), and an MFAS overhead of the fourth ODU0 frame bears a numerical value of 4 (an 8-bit binary number). Based on a maximum numerical value born in the MFAS overheads of different ODU0 frames, it can be determined that the multi-frame contains 4 base frames (i.e., 4 ODU0 frames), thereby determining that N=4. It should be noted that in the case where the MFAS overhead in the OTN frame is reused for multi-frame indication, if the value of N exceeds the maximum multi-frame number 256 that the MFAS can characterize, a two-level multi-frame mode may be adopted for representation, and the specific manner is not described in detail herein.

It should be noted that reusing the MFAS overhead in the OTN frame for multi-frame indication to implement delivery the value of the multiple N is an optional solution in the implementation of the present disclosure, and does not configure any limitation to the technical solution of the present disclosure. In an embodiment of the present disclosure, the value of the multiple N may also be born in other positions of the overhead area.

In practical applications, if cross processing is not desired between a sender device and a receiver device, the mapping latency will have a large influence on the overall latency. In order to reduce the mapping latency, the smaller the length of the unit block, the better. In other words, the smaller the value of the multiple N, the better. For example, at the sending side, the value of the multiple N is configured to be 1 (which may be configured manually, or configured based on a certain rule by the sender device according to the network architecture between the sender device and the receiver device). For example, one ODU0 frame is divided into 952 unit blocks of 16 bytes, that is, the basic unit has a size of 16 bytes, then N=1, and the multiple N=1 and the length U=16 bytes are delivered over the overhead area of ODU0 frame (where some of OPU overhead may be used).

If cross processing is desired between the sender device and the receiver device, the cross processing will have a large influence on the overall latency. In order to reduce the cross processing latency, a length of the unit block should equal to a length of a cross unit used in the cross processing (the length of the unit block is as close as possible to the length of the cross unit used in the cross processing), so that a packet cutting and recombining process can be omitted, and some of the cross processing latencies can be saved. For example, assuming that the cross unit used in the cross processing has a length of 256 bytes, the length of the unit block may be then set to 256 bytes. If the basic unit has a length of 16 bytes, then it may be calculated that N takes a value of 16. That is, one unit block includes 16 continuous basic units, and the multiple N=16 and the length U=16 bytes are transported over the overhead area of ODU0 frame (where a partial OPU overhead may be used). The multiple N of “16” and the length U of “16” bytes may be born and delivered in the overhead areas of the first, last, or each ODU0 frame of the 16 ODU frames.

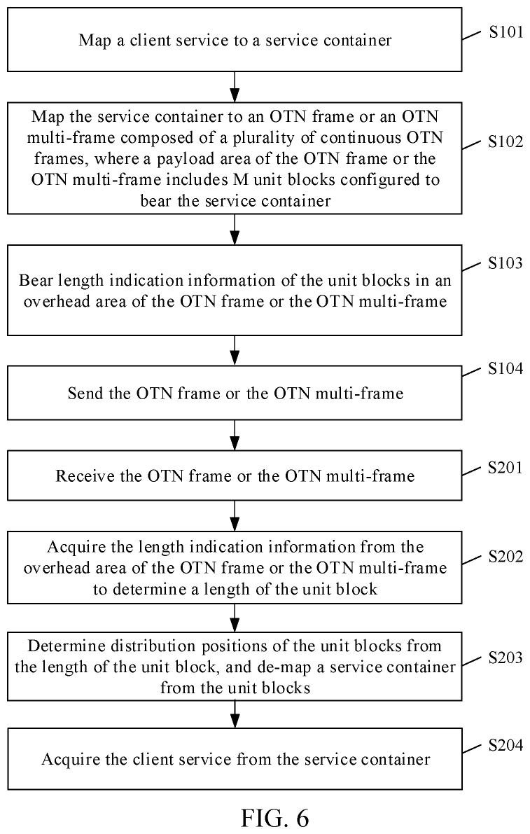

FIG. 6 is a flowchart of another service processing method in OTN according to an embodiment of the present disclosure. As shown in FIG. 6, in addition to the above operations S101 to S104, the method further includes: operations S201 to S204, where operations S101 to S104 are applied to the sending side, and operations S201 to S204 are applied to the receiving side. Merely operations S201 to S204 will be described in detail below.

At operation S201, receiving the OTN frame or the OTN multi-frame.

At operation S202, acquiring the length indication information from the overhead area of the OTN frame or the OTN multi-frame to determine the length of the unit block.

At operation S203, determining distribution positions of the unit block from the length of the unit blocks, and demapping a service container from the unit blocks.

At operation S204, acquiring the client service from the service container.

The technical solutions of the present disclosure will be described in detail below with reference to specific examples.

### Example 1

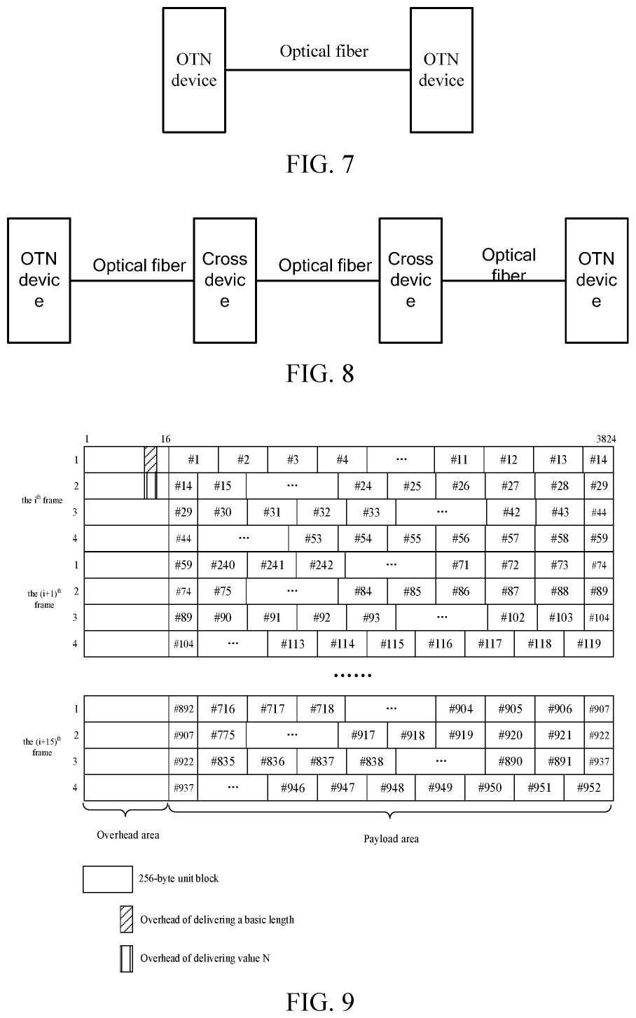

FIG. 7 is a schematic diagram of a service transmission scenario of example 1. As shown in FIG. 7, cross processing is not desired between two OTN devices. Assuming that two OTN devices transmit 10 client services of 30 Mbps bandwidth through OTU2 frames, where the 10 client services are respectively born in 10 different OSU service containers, which are OSU #1 to OSU #10. The length of the basic unit is 16 bytes.

At operation 1, at the sending side, since cross processing is not desired, the mapping latency will have a large influence on the overall latency. In order to reduce the mapping latency, the smaller the length of the unit block, the better. In other words, the smaller the value of the multiple N, the better. Assuming that the determined multiple N takes a value of 1, then the length of each unit block is 1*16 bytes. At this time, a mapping latency from the service container to the unit block is about 16*8 bit/30 Mbps≈4.27 μs.

At operation 2, at the sending side, on the basis of one ODU0 frame, an ODU0 payload area is divided into 952 unit blocks of 16 bytes, where each unit block has a bandwidth of 1.3 Mbps, each OSU service is mapped to 30 Mbps/1.3 Mbps≈24 unit blocks, and the 10 service containers OSU #1 to OSU #10 are mapped to a total of 240 unit blocks.

At operation 3, at the sending side, the basic unit length U=16 bytes and the multiple N=1 are transmitted in the overhead area of the OPU0 frame, where the length U occupies 1 byte, i.e., the 15th byte in row 1 of the ODU0 frame; and the value of the multiple N occupies 1 byte, i.e., the 15th byte in row 2 of the ODU0 frame (as shown in FIG. 5).

At operation 4, at the sending side, the ODU0 is mapped to an ODU2 and encapsulated in an OTU2 for transmitting.

At operation 5, at the receiving side, the OTU2 is received and decapsulated to the ODU2, where the ODU0 is resolved and the length U and the multiple N are extracted from the overhead of the ODU0, and it is calculated that the unit block has a size of 16 bytes.

At operation 6, with one ODU0 as a unit, the 952 unit blocks are identified, and the service containers OSU #1 to OSU #10 are demapped from the corresponding unit blocks, thereby obtaining corresponding client service data.

### Example 2

FIG. 8 is a schematic diagram of a service transmission scenario of example 2. As shown in FIG. 8, cross processing is desired between two OTN devices. Assuming that two OTN devices transmit 10 client services of 30 Mbps bandwidth through OTU2 frames, where the 10 client services are respectively born in 10 different OSU service containers, which are OSU #1 to OSU #10. The length of the basic unit is 16 bytes.

At operation 1, at the sending side, since cross processing is desired, the cross latency will have a large influence on the overall latency. In order to reduce the cross latency, the closer the length of the unit block is to the length of the cross unit used in the cross processing, the better. Assuming that the determined multiple N takes a value of 16, then the length of each unit block is 16*16=256 bytes. At this time, a mapping latency from the service container to the unit block is about 256*8 bit/30 Mbps≈68.32 μs.

FIG. 9 is a schematic diagram showing payload areas of 16 continuous ODU0 frames divided into 952 unit blocks. As shown in FIG. 9, at operation 2, at the sending side, on the basis of 16 continuous ODU0 frames, a payload area of a multi-frame composed of the 16 continuous ODU0 frames is divided into 952 unit blocks of 256 bytes, where each unit block has a bandwidth of 1.3 Mbps, each OSU service is mapped to 30 Mbps/1.3 Mbps≈24 unit blocks, and the 10 service containers OSU #1 to OSU #10 are mapped to a total of 240 unit blocks.

At operation 3, at the sending side, the basic unit length U=16 bytes and the multiple N=16 are transmitted in the overhead area of the OPU0 frame, where the length U occupies 1 byte, i.e., the 15th byte in the first row of the ODU0 frame; and the value of the multiple N occupies 1 byte, and i.e., the 15th byte in the second row of the ODU0 frame (as shown in FIG. 5).

At operation 4, at the sending side, the ODU0 is mapped to an ODU2 and encapsulated in an OTU2 for transmitting.

At operation 5, at the receiving side, the OTU2 is received and decapsulated to the ODU2, where the ODU0 is resolved and the length U and the multiple N are extracted from the overhead of the ODU0, and it is calculated that the unit block has a size of 16*16=256 bytes.

At operation 6, taking the multi-frame composed of the 16 continuous ODU0 frames as a unit, the 952 unit blocks are identified, and the service containers OSU #1 to OSU #10 are demapped from the corresponding unit blocks, thereby obtaining corresponding client service data.

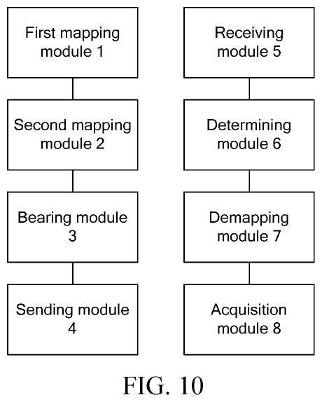

FIG. 10 is a block diagram of a service processing apparatus in an OTN according to an embodiment of the present disclosure. As shown in FIG. 10, the service processing apparatus may be configured to implement the service processing method according to any of the above embodiments, and the service processing apparatus includes: a first mapping module 1, a second mapping module 2, a bearing module 3, and a sending module 4.

The first mapping module 1 is configured to map a client service to a service container.

The second mapping module 2 is configured to map the service container to an OTN frame or an OTN multi-frame composed of a plurality of continuous OTN frames, a payload area of the OTN frame or the OTN multi-frame including M unit blocks configured to bear the service container.

The bearing module 3 is configured to bear length indication information of the unit blocks in an overhead area of the OTN frame or the OTN multi-frame.

The sending module 4 is configured to send the OTN frame or the OTN multi-frame.

Based on the first mapping module 1, the second mapping module 2, the bearing module 3 and the sending module 4, the service transmission can be implemented.

In some embodiments, the processing apparatus further includes: a receiving module 5, a determining module 6, a demapping module 7, and an acquisition module 8.

The receiving module 5 is configured to receive the OTN frame or the OTN multi-frame.

The determining module 6 is configured to acquire the length indication information from the overhead area of the OTN frame or the OTN multi-frame to determine a length of the unit block.

The demapping module 7 is configured to determine distribution positions of the unit blocks from the length of the unit block, and demap a service container from the unit blocks.

The acquisition module 8 is configured to acquire the client service from the service container.

Based on the receiving module 5, the determining module 6, the demapping module 7, and the acquisition module 8, the service reception can be implemented.

For specific description of the respective modules in the embodiment, the references may be made to corresponding contents in the foregoing embodiments, and will not be repeated here.

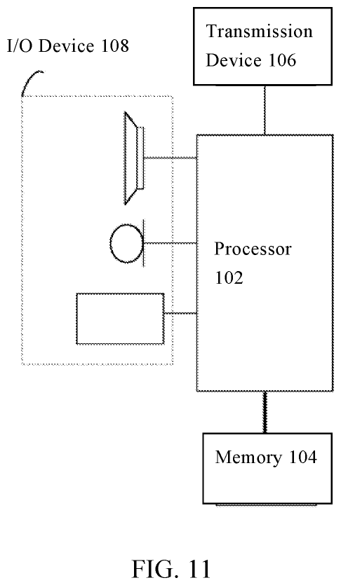

FIG. 11 is a block diagram of an electronic device according to an embodiment of the present disclosure. As shown in FIG. 10, the electronic device 11 may be a mobile terminal, a computer terminal or any other similar computing device. The electronic device 10 includes one or more processors 102 (merely one is shown in the figure, and the processor 102 may include, but are not limited to, a processing device such as a microprocessor (MPU) or a programmable logic device (PLD)), and a memory 104. The memory 104 has one or more programs stored thereon which, when executed by the one or more processors 102, cause the one or more processors to implement operations of the processing method according to any one of the foregoing embodiments.

In some embodiments, the mobile terminal may further include a transmission means 106 for communication functions and an input/output means 108. It will be understood by those ordinary skilled in the art that the structure shown in FIG. 11 is merely illustrative, and does not form any limitation to the structure of the above mobile terminal. For example, the mobile terminal 10 may include more or fewer components than those shown in FIG. 11, or have a different configuration than that shown in FIG. 11.

The memory 104 may be configured to store a computer program, for example, an application software program or a module, such as a computer program corresponding to the service processing method in an OTN in the embodiment of the present disclosure. The processor 102 executes the computer program stored in the memory 104 to perform various functional applications and data processing, that is, implement the above method. The memory 104 may include a high speed random access memory and further a non-volatile memory, such as one or more magnetic storage devices, flash memories, or other non-volatile solid state memories. In some examples, the memory 104 may further include a memory remotely located relative to the processor 102, which may be connected to the mobile terminal 10 over a network. Examples of such networks include, but are not limited to, the Internet, intranets, local area networks, mobile communication networks, and combinations thereof.

The transmission means 106 is configured to receive or send data over a network. Specific examples of such networks may include a wireless network provided by a communication provider of the mobile terminal 10. In an example, the transmission means 106 includes a network interface controller (NIC) that may be connected to another network device through a base station to communicate with the Internet. In an example, the transmission device 106 may be a radio frequency (RF) module configured to communicate with the Internet wirelessly.

An embodiment of the present disclosure further provides a computer-readable medium having a computer program stored thereon which, when executed by a processor, causes operations of the processing method according to any one of the foregoing embodiments to be implemented.

Those of ordinary skill in the art will appreciate that all or some operations of the above described method, functional modules/units in the system and apparatus may be implemented as software, firmware, hardware, and suitable combinations thereof. In a hardware implementation, the division between the functional modules/units mentioned in the above description does not necessarily correspond to the division of physical components; for example, one physical component may have multiple functions, or one function or operation may be performed cooperatively by several physical components. Some or all physical components may be implemented as software executed by a processor, such as a CPU, a digital signal processor or microprocessor, or implemented as hardware, or implemented as an integrated circuit, such as an application specific integrated circuit. Such software may be distributed on a computer readable medium which may include a computer storage medium (or non-transitory medium) and a communication medium (or transitory medium). As is well known to those of ordinary skill in the art, the term computer storage medium includes volatile and nonvolatile, removable and non-removable medium implemented in any method or technology for storing information, such as computer readable instructions, data structures, program modules or other data. The computer storage medium includes, but is not limited to a read-only memory (ROM), a random access memory (RAM), an electrically erasable programmable read-only memory (EEPROM), a flash memory or any other memory technology, a compact disc read-only memory (CD-ROM), a digital video disc (DVD) or any other optical disc storage, magnetic cartridge, magnetic tape, magnetic disk storage or any other magnetic storage device, or any other medium that can be used to store the desired information and accessed by a computer. Moreover, it is well known to one of ordinary skill in the art that a communication medium typically includes a computer-readable instruction, a data structure, a program module, or other data in a modulated data signal, such as a carrier wave or other transport mechanism, and may include any information delivery medium.

The present disclosure has disclosed example embodiments, and although specific terms are employed, they are used and should be interpreted in a generic and descriptive sense only and not for purposes of limitation. In some instances, features, characteristics and/or elements described in connection with a particular embodiment may be used alone or in combination with features, characteristics and/or elements described in connection with other embodiments, unless expressly stated otherwise, as would be apparent to one skilled in the art. It will, therefore, be understood by those skilled in the art that various changes in form and details may be made therein without departing from the scope of the present disclosure as set forth in the appended claims.

1. A service processing method in an optical transport network (OTN), comprising:
mapping a client service to a service container;
mapping the service container to an OTN frame or an OTN multi-frame composed of a plurality of continuous OTN frames, wherein a payload area of the OTN frame or the OTN multi-frame comprises M unit blocks configured to bear the service container;
bearing length indication information of the unit blocks in an overhead area of the OTN frame or the OTN multi-frame; and
sending the OTN frame or the OTN multi-frame.

2. The method according to claim 1, wherein the unit block has a length N times a basic unit, and when the payload area of a single OTN frame is divided into M unit blocks having an equal length, a length U of the basic unit equals to a length of one unit block, where N is a positive integer.

3. The method according to claim 2, wherein before bearing the length indication information of the unit blocks in the overhead area of the OTN frame or the OTN multi-frame, the method further comprises:
determining a value of the multiple N.

4. The method according to claim 2, wherein when N>1, the service container is mapped to an OTN multi-frame composed of N continuous OTN frames, the payload area of the OTN multi-frame is divided into M unit blocks each having a length of N*U, and some of bits in the overhead area of the OTN frame are used for multi-frame counting statistics of the N OTN frames.

5. The method according to claim 2, wherein the length indication information comprises the multiple N;
or the length indication information comprises the multiple N and the length U.

6. The method according to claim 1, wherein the service container comprises: an optical channel data unit (ODU) frame or an optical service unit (OSU) frame.

7. The method according to claim 1, further comprising:
receiving the OTN frame or the OTN multi-frame;
acquiring the length indication information from the overhead area of the OTN frame or the OTN multi-frame to determine a length of each unit block;
determining distribution positions of the unit blocks from the length of each unit block, and de-mapping a service container from the unit blocks; and
acquiring the client service from the service container.

8. A service processing apparatus in an optical transport network (OTN), comprising:
a first mapping module configured to map a client service to a service container;
a second mapping module configured to map the service container to an OTN frame or an OTN multi-frame composed of a plurality of continuous OTN frames, wherein a payload area of the OTN frame or the OTN multi-frame comprises M unit blocks configured to bear the service container;
a bearing module configured to bear length indication information of the unit blocks in an overhead area of the OTN frame or the OTN multi-frame; and
a sending module configured to send the OTN frame or the OTN multi-frame.

9. The apparatus according to claim 8, further comprises:
a receiving module configured to receive the OTN frame or the OTN multi-frame;
a determining module configured to acquire the length indication information from the overhead area of the OTN frame or the OTN multi-frame to determine a length of the unit block;
a de-mapping module configured to determine distribution positions of the unit blocks from the length of the unit block, and de-map a service container from the unit blocks; and
an acquisition module configured to acquire the client service from the service container.

10. An electronic device, comprising:
at least one processor;
a memory having at least one program stored thereon which, when executed by the at least one processor, cause the at least one processor to implement the method according to claim 1.

11. A computer-readable medium having a computer program stored thereon which, when executed by a processor, causes the method according to claim 1 to be implemented.

12. The method according to claim 2, further comprising:
receiving the OTN frame or the OTN multi-frame;
acquiring the length indication information from the overhead area of the OTN frame or the OTN multi-frame to determine a length of each unit block;
determining distribution positions of the unit blocks from the length of each unit block, and de-mapping a service container from the unit blocks; and
acquiring the client service from the service container.

13. The method according to claim 3, further comprising:
receiving the OTN frame or the OTN multi-frame;
acquiring the length indication information from the overhead area of the OTN frame or the OTN multi-frame to determine a length of each unit block;
determining distribution positions of the unit blocks from the length of each unit block, and de-mapping a service container from the unit blocks; and
acquiring the client service from the service container.

14. The method according to claim 4, further comprising:
receiving the OTN frame or the OTN multi-frame;
acquiring the length indication information from the overhead area of the OTN frame or the OTN multi-frame to determine a length of each unit block;
determining distribution positions of the unit blocks from the length of each unit block, and de-mapping a service container from the unit blocks; and
acquiring the client service from the service container.

15. The method according to claim 5, further comprising:
receiving the OTN frame or the OTN multi-frame;
acquiring the length indication information from the overhead area of the OTN frame or the OTN multi-frame to determine a length of each unit block;
determining distribution positions of the unit blocks from the length of each unit block, and de-mapping a service container from the unit blocks; and
acquiring the client service from the service container.

16. The method according to claim 6, further comprising:
receiving the OTN frame or the OTN multi-frame;
acquiring the length indication information from the overhead area of the OTN frame or the OTN multi-frame to determine a length of each unit block;
determining distribution positions of the unit blocks from the length of each unit block, and de-mapping a service container from the unit blocks; and
acquiring the client service from the service container.
